(19) United States
(12) Patent Application Publication
(10) Pub. No.: US 2017/0374342 A1
(43) Pub. Date: Dec. 28, 2017

(54) LASER-ENHANCED VISUAL SIMULTANEOUS LOCALIZATION AND MAPPING (SLAM) FOR MOBILE DEVICES

(71) Applicant: iSee, Inc., Cambridge, MA (US)

(72) Inventor: Yibiao ZHAO, Cambridge, MA (US)

(21) Appl. No.: 15/192,638

(22) Filed: Jun. 24, 2016

(51) Int. Cl. H04N 13/00; H04N 13/02; G01B 11/25; G02B 27/09

(52) U.S. Cl. CPC H04N 13/0022; G02B 27/0955; H04N 13/0271; G01B 11/2518; G02B 27/0933; H04N 2013/0081

(57) ABSTRACT

Laser-enhanced visual simultaneous localization and mapping (SLAM) is disclosed. A laser line is generated, the laser line being incident on an object and/or environment. While the laser line is incident on the object, one or more images of the object with the laser line incident on the object are captured. The camera is localized based on one or more characteristics of the laser line incident on the object. In some examples, improved feature localization provided by the laser line provides more accurate camera localization, which, in turn, improves the accuracy of the stitched mesh of the object/environment. As such, the examples of the disclosure provide for improved camera localization and improved three-dimensional mapping.

### FIELD OF THE DISCLOSURE

This relates generally to localization of a camera and/or mapping of a 3D environment on a mobile device using a visual SLAM solution that is enhanced using a laser line process.

### BACKGROUND OF THE DISCLOSURE

Visual simultaneous localization and mapping (SLAM) algorithms enable a mobile device to simultaneously build 3D maps of the world while tracking the location and orientation of a camera. The camera can be hand-held or head-mounted for Virtual Reality (VR)/Augmented Reality (AR) solutions, or mounted on a robot, a drone or a car. The visual SLAM algorithms are solely based on an on-board camera without the need for any external localization device or system; thus, they are also referred to as “inside-out” tracking solutions, which are increasingly popular for VR/AR and robotics applications. However, visual SLAM suffers from three main drawbacks: 1) the visual SLAM algorithm can only produce a sparse point cloud of feature points—as such, even recent development of direct SLAM algorithms may fail to recover large flat (e.g., texture-less) areas, such as white walls; 2) the recovered 3D map of the environment does not have an absolute scale of the world; and 3) the SLAM algorithms are fragile and easy to lose when there are few features presented in the image frames.

The depth sensor using stereo technique, structured light technique, and time of flight (TOF) techniques are increasingly popular for offering a dense depth image of a scene. However, such solutions are often expensive, have high power consumption, and large size. The standard Kinectfusion type of algorithms require high-end GPUs and a large memory space for storing the volumetric data, which is not affordable for current embedded devices.

### SUMMARY OF THE DISCLOSURE

Examples of the disclosure are directed to laser-enhanced visual SLAM solutions, which use a laser line generator with accurate 3D measurement to enhance the accuracy and robustness of camera localization and at the same time the density of the environment mapping. Some examples are directed to laser-enhanced scanning of an object in three dimensions, as well as tracking (e.g., in six degrees of freedom (DOF)) the position and/or orientation of a camera. In some examples, a SLAM device/system of the disclosure, which can include one or more cameras and one or more laser line generators, can scan an object in three dimensions using a laser line while having the ability to move freely with respect to the object, and without requiring analysis and/or capture of a reference image for calibrating or registering the SLAM device.

### BRIEF DESCRIPTION OF THE DRAWINGS

FIG. 1 illustrates an exemplary laser-enhanced SLAM device configuration according to examples of the disclosure.

FIGS. 2A-2F illustrate an exemplary method of laser-enhanced SLAM according to examples of the disclosure.

FIG. 3A illustrates an exemplary process of laser-enhanced SLAM according to examples of the disclosure.

FIG. 3B illustrates a feedback loop that can be a characteristic of the process of FIG. 3A.

FIG. 4 illustrates an exemplary multi-wavelength laser generation configuration according to examples of the disclosure.

FIG. 5 illustrates an exemplary cold mirror image capture implementation according to examples of the disclosure.

FIGS. 6A-6D illustrate exemplary details of laser line generators for use as attachments to a headphone jack on a device according to examples of the disclosure.

FIGS. 7A-7C illustrate exemplary techniques for moving the laser line across an object being scanned without needing to move the SLAM device, according to examples of the disclosure.

FIG. 8 illustrates an exemplary block diagram of a SLAM device according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

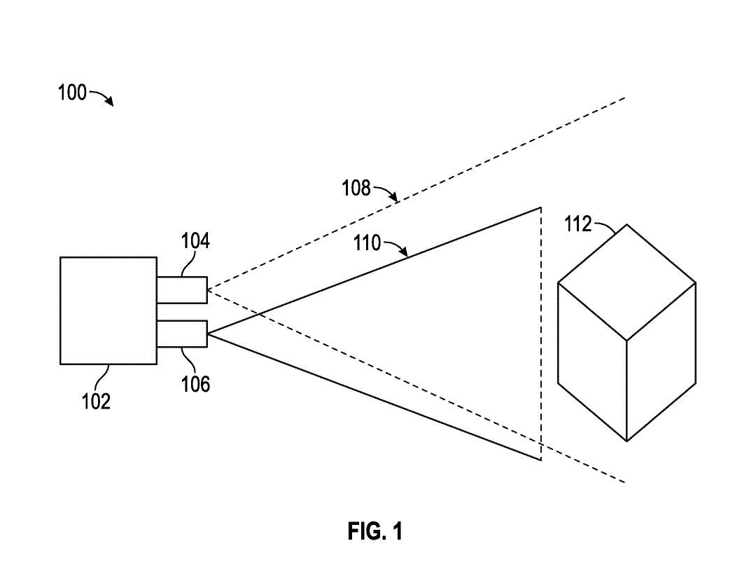

FIG. 1 illustrates an exemplary laser-enhanced SLAM device configuration 100 according to examples of the disclosure. SLAM device 102 can include an optical camera 104 and a laser line generator 106. Optical camera 104 can be any kind of optical camera, such as an RGB sensor-based optical camera. Laser line generator 106 can be any kind of laser generator that can generate a laser line across an object to be scanned by SLAM device 102, as will be described in more detail below. In some examples, the laser line can be generated by the SLAM device by fanning out a laser beam into a laser plane using an appropriate lens (such as a Powell lens or cylindrical lens arrays), a fast-spinning mirror and/or using a phased array laser beam generator. In some examples, optical camera 104 and laser line generator 106 can be fixedly disposed with respect to each other and/or with respect to device 102. SLAM device 102 can be any kind of electronic device, such as a smartphone or a VR/AR headset (e.g., into which optical camera 104 can be built and to which laser line generator 106 can be attached as an attachment), a dedicated 3D scanning device (e.g., into which optical camera 104 and laser line generator 106 can be built) and/or any robotics platform, such as a drone (e.g., to which optical camera 104 and laser line generator 106 can be attached as attachments)—other electronic devices into or to which optical camera 104 and/or laser line generator 106 can be built or attached, respectively, can similarly be utilized.

Laser line generator 106 can generate a laser line 110 within field of view 108 of optical camera 104. In order to scan an object (e.g., object 112) in three dimensions according to examples of the disclosure, a user of device 102 (or a mechanical system controlling the position of device 102) can appropriately move device 102 such that laser line 110 is scanned across some or all of object 112 while optical camera 104 is capturing at least laser line 110 on the surface(s) of object 112. In doing so, device 102 can generate a three-dimensional scan of object 112 to create a three-dimensional point cloud or mesh of object 112, as will be described in more detail below. It is understood that while the examples of the disclosure are described in the context of scanning a single object (e.g., object 112), the examples of the disclosure can similarly be utilized to scan multiple objects, as well as the background environment, concurrently. Further, while the examples of the disclosure are described in the context of scanning an object in three dimensions, it is understood that the examples of the disclosure additionally or alternatively track the position and/or orientation of a camera relative to an object (and/or track the position/orientation of the object relative to the camera), as will be mentioned below, as appropriate.

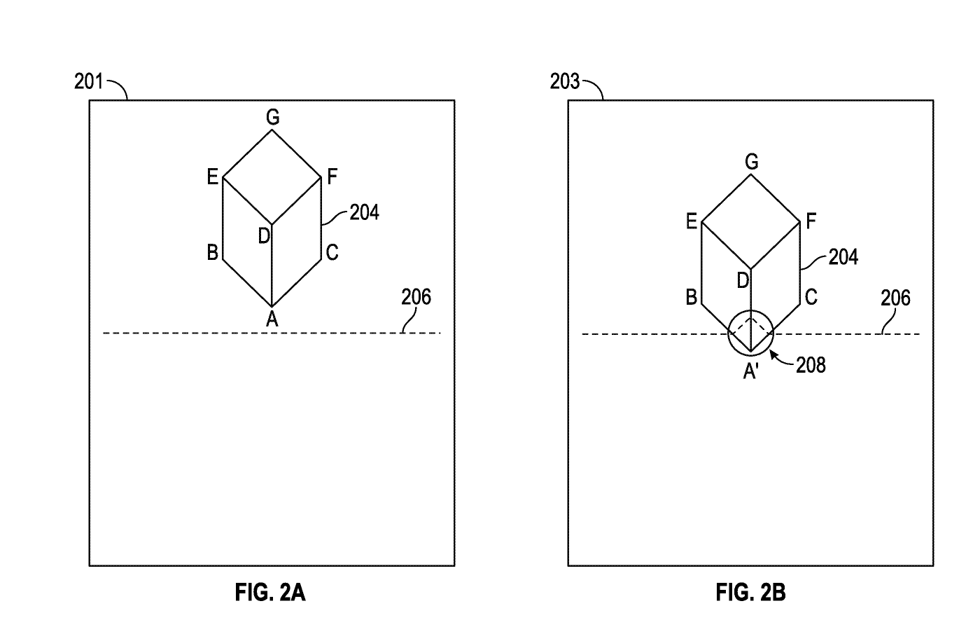

FIGS. 2A-2F illustrate an exemplary method of laser-enhanced SLAM according to examples of the disclosure. FIG. 2A shows image 201 captured by an optical camera (e.g., optical camera 104 in FIG. 1) on a SLAM device (e.g., device 102 in FIG. 1). Image 201 can include object 204 having one or more features (e.g., edges, corners, surfaces, etc.) that can be identified by the device of the disclosure. The features of object 204 that will be discussed for the purpose of this disclosure will be corners A-G, though it is understood that other features of an object being scanned in accordance with the examples of the disclosure can similarly be additionally or alternatively utilized. The SLAM device of the disclosure can also illuminate the scene in image 201 with a laser line 206. In FIG. 2A, laser line 206 is not incident on object 204. When image 201 is captured by the device, the device can also identify laser line 206 and its location in image 201. The device can identify laser line 206 in image 201 using any suitable technique, such as searching for a substantially linear feature in image 201 having a certain color (e.g., the color of the laser line, such as red or green). In FIG. 2A, the device can identify that laser line 206 is not incident on object 204.

When image 201 is captured by the device, the device can identify one or more features of object 204 using suitable feature detection techniques, such as scale-invariant feature transform (SIFT), speeded up robust features (SURF), oriented FAST and rotated BRIEF (ORB) and FAST techniques. For example, the device can identify corners A-G of object 204 upon capturing image 201. The device can also determine, using optical image processing techniques, initial three-dimensional positions of corners A-G of object 204. Using the determined initial three dimensional positions of corners A-G of object 204, the device can localize (e.g., in some examples, simultaneously with determining the initial three dimensional positions of corners A-G of object 204), in three dimensions, the position and/or orientation of the camera (and thus the SLAM device) that is capturing image 201 with respect to corners A-G (and thus object 204). Such localization can be performed using any suitable localization technique, such as various simultaneous localization and mapping (SLAM) and Structure from Motion (SFM) (e.g., Extended Kalman Filter (EKF) or Bundle Adjustment (BA)) algorithms.

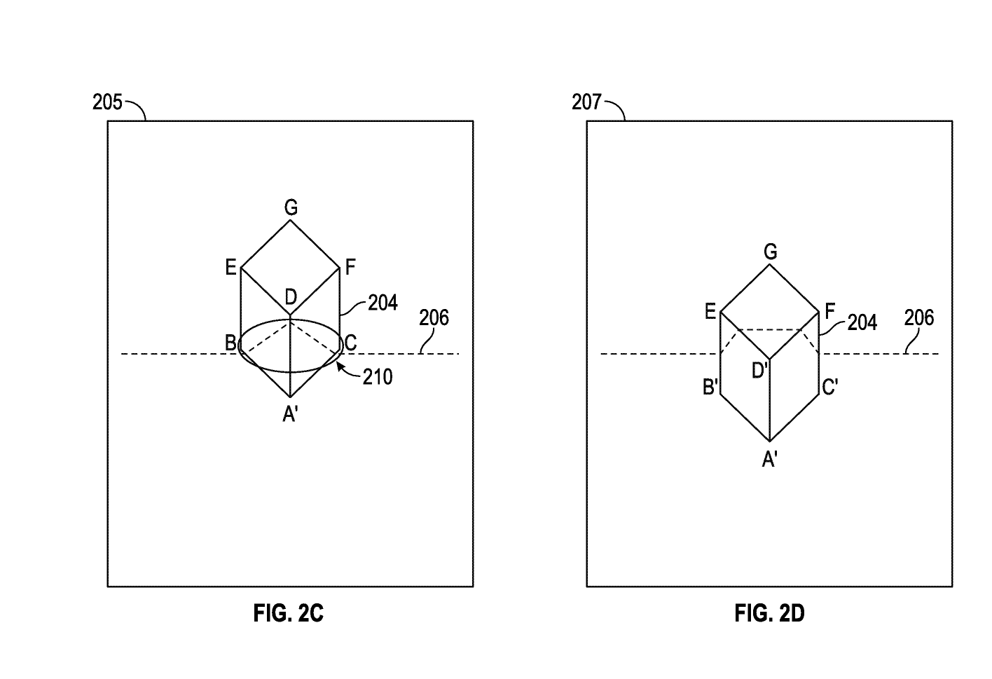

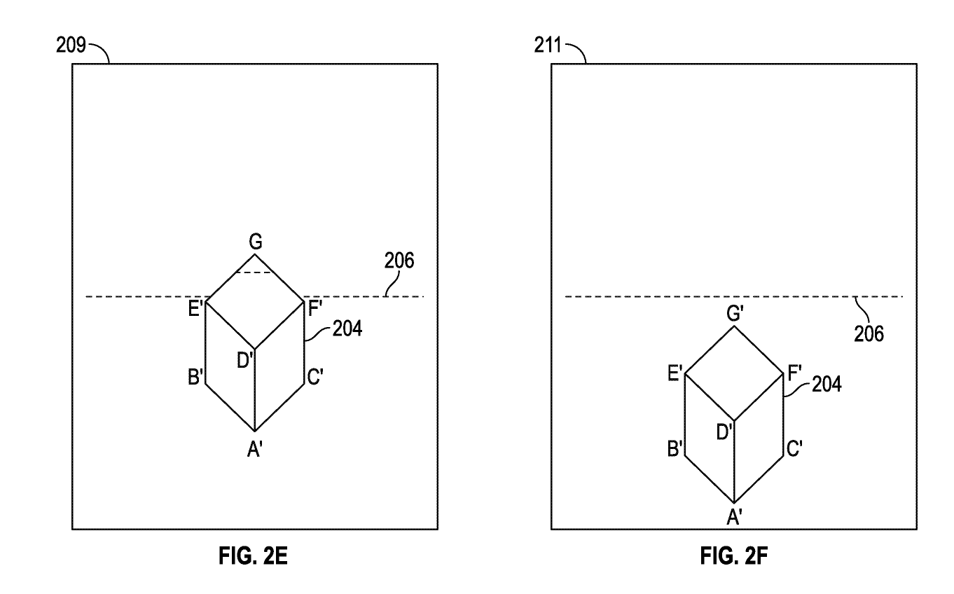

In some examples, the three dimensional positions of corners A-G of object 204, and thus the resulting localization of the camera of the device, which can be based on the positions of corners A-G, can be improved by identifying the deflection(s) of laser line 206 as it passes over object 204 as a user moves the SLAM device appropriately. Such deflections of laser line 206 can provide substantial improvement in the positions of corners A-G of object 204 determined using the above optical image processing techniques, based at least on providing relatively accurate information about the relative positions of corners A-G with respect to each other and/or other features of object 204 (e.g., surfaces, edges, etc.). Specifically, the SLAM device can: 1) reconstruct the three-dimensional profile of (points on) the laser line in the captured images, and 2) if the laser line is coincident with one or more of the object features described above (e.g., one or more of corners A-G of object 204), improve the three-dimensional positions of the one or more object features, with which the laser line is coincident, using the reconstructed three-dimensional profile of (the points on) the laser line. Exemplary techniques for reconstructing the three-dimensional profile of (points on) a laser line based on laser line deflection by triangulation are described in Latimer, W., “Understanding laser-based 3D triangulation methods,” Vision Systems Design (June 2015), which is hereby incorporated by reference in its entirety for all purposes. As such, a user can move the SLAM device to cause laser line 206 to pass over object 204 to improve the initial three dimensional locations of corners A-G determined using optical image processing techniques, alone, which can then be used to improve the localization of the camera determined based on, for example, SLAM/SFM algorithms by incorporating the improved three-dimensional locations of corners A-G as constraints (e.g., hard constraints) in their respective optimization algorithms. Improving the localization of the camera with respect to object 204 can improve the SLAM device's ability to accurately combine data from the multiple images captured by the camera of the object as the laser line is scanned across object 204 to create a three-dimensional point cloud or mesh of object 204, as will be described in more detail with reference to FIG. 3A. The various features of the SLAM techniques of the disclosure, including the laser-enhanced object feature position determinations, allow the SLAM device to create a three-dimensional point cloud or mesh of object 204 without the need for a reference marker or similar object (e.g., a reference 3D shape), which greatly enhances the flexibility and versatility of the SLAM techniques disclosed. Further, the SLAM device (and thus the camera and the laser line generator mounted on the SLAM device) is free to move with respect to the object being scanned while the SLAM is taking place.

FIG. 2B illustrates laser line 206 having passed over a portion of object 204. Specifically, a user has moved the SLAM device (including a camera capturing image 203 and a laser line generator generating laser line 206) up with respect to object 204. Thus, object 204 has shifted slightly down in image 203, and laser line 206 has passed over corner A of object 204. While and after laser line 206 has passed over corner A, device can identify deflections 208 in laser line 206 to improve the determined three dimensional position of corner A (illustrated as A′ in FIG. 2B), as discussed above. In some examples, the device can utilize the improved position of corner A′, and the initial positions of corners B-G, to improve the localization of the camera at this stage. Further, in some examples, deflections 208 identified in laser line 206 up to this point can also be used to improve the determined three dimensional positions of corners B-G, which can in turn be utilized to further improve the localization of the camera. The above-described procedures can be continually and/or periodically repeated as the user continues to move the device until laser line 206 passes over the entirety of object 204. The above-described operations will be described in more detail with reference to FIG. 3A, below.

FIG. 2C illustrates further movement of laser line 206 over object 204. In FIG. 2C, laser line 206 has further deflected, and/or has different deflections 210 with respect to laser line 206 in FIG. 2B, because laser line 206 is incident on a different portion of object 204 than in FIG. 2B. The device can identify deflections 210, and based on these deflections, can continue to improve the three dimensional positions of corners A-G and/or the localization of the camera, as discussed above with respect to FIG. 2B.

FIGS. 2D-2F illustrate further movement of laser line 206 over object 204. The device can continue to improve the three dimensional positions of corners A-G (e.g., B→B′, C→C′, and D→D′ in FIG. 2D, E→E′ and F→F′ in FIG. 2E, and G→G′ in FIG. 2F) and/or the localization of the camera as laser line 206 passes over corners A-G and/or the entirety of object 204, as discussed above. By the time laser line 206 has passed over the entirety of object 204, the three dimensional features that the device has identified on object 204 (e.g., corners A-G) can have improved three dimensional positions (e.g., compared with positions determined using merely optical image processing techniques), and the location of the camera of the device with respect to object 204 can be determined with improved accuracy. As will be described in more detail with reference to FIG. 3A, the SLAM device can utilize the improved localization of the camera with respect to object 204 as the camera moves and captures multiple images (e.g., images 201, 203, 205, 207, 209 and 211 in FIGS. 2A-2F) of object 204 to create an accurate three-dimensional point cloud or mesh of object 204.

In some examples, the device can continually and/or periodically store the images of object 204 and laser line 206 that are captured (e.g., images 201, 203, 205, 207, 209 and 211 in FIGS. 2A-2F) as laser line 206 is moved across object 204. Each image can be stored in association with the position of laser line 206 in the image, the position(s) of the feature(s) on object 204 identified by the device (e.g., the positions of corners A-G, as described above), and/or the position of the SLAM device/camera with respect to the object (e.g., the position and/or orientation of the SLAM device determined by localizing the camera with respect to the object, as described above). In some examples, the device can further include one or more inertial measurement units (IMUs), measurements from which can be used to further inform the determined position of the device as it moves while the user scans laser line 206 over object 204.

Once laser line 206 has been passed across the entirety of object 204 (in some examples, while the laser line is still being passed across the object), the SLAM device can combine the positional data gathered about the three dimensional structure of object 204 from images 201, 203, 205, 207, 209 and 211in FIGS. 2A-2F to construct a three dimensional point cloud, mesh and/or volume of object 204. The three dimensional point cloud, mesh and/or volume of object 204 can be constructed by combining images in FIGS. 2A-2F using the position of laser line 206 in the images, the deflections of laser line 206 in the images (which can provide a dense collection of three dimensional points on the object), the position(s) of the feature(s) on object 204 identified by the device (e.g., the positions of corners A-G, as described above), and/or the position/orientation of the SLAM device with respect to the object (e.g., the position and/or orientation of the scanning device determined by localizing the camera with respect to the object, as described above). Exemplary techniques for extracting the 3D laser line from the images and combining such images to construct a three dimensional point cloud, mesh and/or volume of an object given the 3D camera position for each image are described in R. Slossberg, Freehand Laser Scanning Using a Mobile Phone, British Machine Vision Conference (2015), which is hereby incorporated by reference in its entirety for all purposes.

FIG. 3A illustrates an exemplary process 300 of laser-enhanced SLAM according to examples of the disclosure. At 302, optical image data (e.g., one or more images) of a laser line and an object (in some examples, multiple objects) can be captured and/or stored by a SLAM device (e.g., device 102 in FIG. 1), as described above with reference to FIGS. 2A-2F.

At 314, one or more features of the object(s) being scanned can be identified and/or extracted from the image data captured at 302, as described above with reference to FIGS. 2A-2F. For example, these features can include one or more of corners, edges, surface, etc. of the object.

At 316, it can be determined whether the image features identified/extracted at 314 match image features that have previously been identified and added to a feature pool corresponding to the object being scanned. For example, image features from image data previously captured of the object can already be stored in the feature pool. These previously stored image features in the feature pool can be compared to the image features currently identified at step 314 to determine if any of the current image features correspond to (e.g., are the same as) the image features stored in the feature pool. If one or more image features identified at 314 do not match image features in the feature pool, the image features can be added to the feature pool at 318 (e.g., and can possibly be matched up with image features identified later in process 300, as described above).

For example, referring back to FIGS. 2A-2F, at FIG. 2A, the SLAM device can identify (among others) corner A of object 204 in image 201 as an image feature. Because image 201 can be the first image of object 204 captured by the SLAM device, corner A may not be in the feature pool yet. Thus, the SLAM device can add corner A to the feature pool. Later, at FIG. 2B, the SLAM device can again identify (among others) corner A of object in image 203 as an image feature. This time, because corner A can already be in the feature pool, the SLAM device can determine that corner A identified in image 203 matches (e.g., corresponds to) corner A identified in image 201 (and stored in the feature pool). The above can be performed for one or more image features identified in the image data at 314.

If, at 316, one or more image features identified at 314 do match image features in the feature pool, the SLAM device can, at 320, determine the three dimensional positions of the image features matched at 316 (e.g., the three dimensional positions of the image features relative to each other, and/or the absolute three dimensional positions of the image features), can associate the three dimensional positions with their corresponding features in the feature pool, and can add the matched features to the feature pool at 318. The three dimensional positions of the matched features can be determined based on some or all of the captured image data that corresponds to the matched features. Exemplary techniques for determining three-dimensional positions of features in image data can include SIFT, SURF, ORB and FAST techniques. Further, in some examples, the three dimensional positions determined for the matched features at 320 can be used to improve the three dimensional positions of other features in the feature pool. In some examples, the SLAM device may only determine the three dimensional positions of the features at 320 if there are more than a threshold number (e.g., 5, 10 or 20) of features that match features in the feature pool. In some examples, there must be more than the threshold number of current features that match features in the feature pool to satisfy the above condition. In some examples, there must be more than the threshold number of current features that match features in the feature pool and/or past features that have been matched to satisfy the above condition.

Based on the determined three dimensional positions of the one or more features in the feature pool, the SLAM device, at 320, can also localize the camera (and/or the device including the camera) with respect to the object(s) and scene being scanned, as described above with reference to FIGS. 2A-2F. In some examples, the SLAM device can further include one or more inertial measurement units (IMUs), measurements from which can be used to further inform the determined position/rotation of the SLAM device as it moves while the user scans the laser line across the object(s) and scene being scanned.

After steps 318 and 320, process 300 can return to step 302 to capture further image data of the object(s) being scanned, until the object scanning process is complete.

In some examples, steps 314, 316, 318 and 320 of process 300 can be performed on the SLAM device in parallel with steps 304, 306, 308, 309, 310 and 312 of process 300, as will be described below.

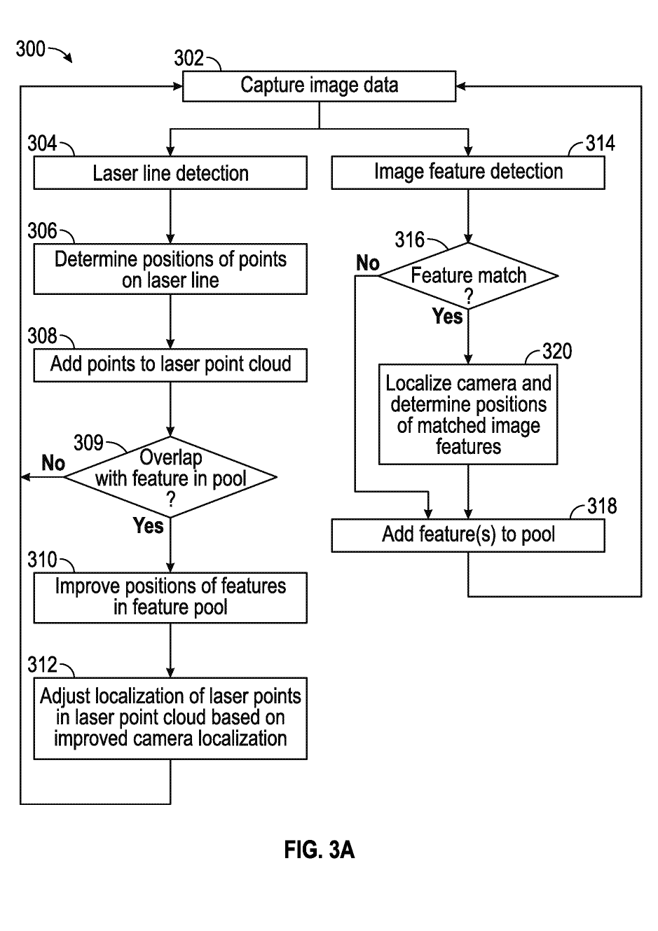

At 304, the existence and/or location of the laser line in the image data can be determined. In some examples, the laser line can be detected by searching for a substantially linear feature in the image data having a certain color (e.g., the color of the laser). In some examples, the device can generate two or more laser lines of different wavelengths (e.g., a red laser line next to a green laser line) to facilitate detection of the laser line in the image data. In such examples, the device can search for two or more substantially adjacent linear features in the image data having certain colors (e.g., red and green) to determine the locations of the laser lines. Using two or more laser lines having different wavelengths can reduce the likelihood that colors and/or features of the object and/or its environment would hide the laser lines in the image data. An exemplary implementation of using multiple laser lines of different wavelengths is described below with reference to FIG. 4.

In some examples, the device can include a laser generator that can generate one or more laser lines of dynamically-determined wavelengths depending on one or more characteristics of the images being captured. In such examples, the device can capture an image of the object and/or it environment to determine the colors of the object and/or it environment. The device can then dynamically determine a color with which to generate a laser line that will visually stand out against the colors of the object and/or its environment. As such, the visibility of the laser(s) in the image data can be improved, and detection of the laser(s) in the image can be facilitated.

In some examples, to facilitate identification of the laser line at 304, the visibility of the laser line in the captured images can be improved by applying a narrow band pass filter to the image data that suppresses wavelengths other than the wavelength(s) of the laser(s) in the image data. As such, the visibility of the laser(s) in the image data can be improved, and detection of the laser(s) in the image can be facilitated.

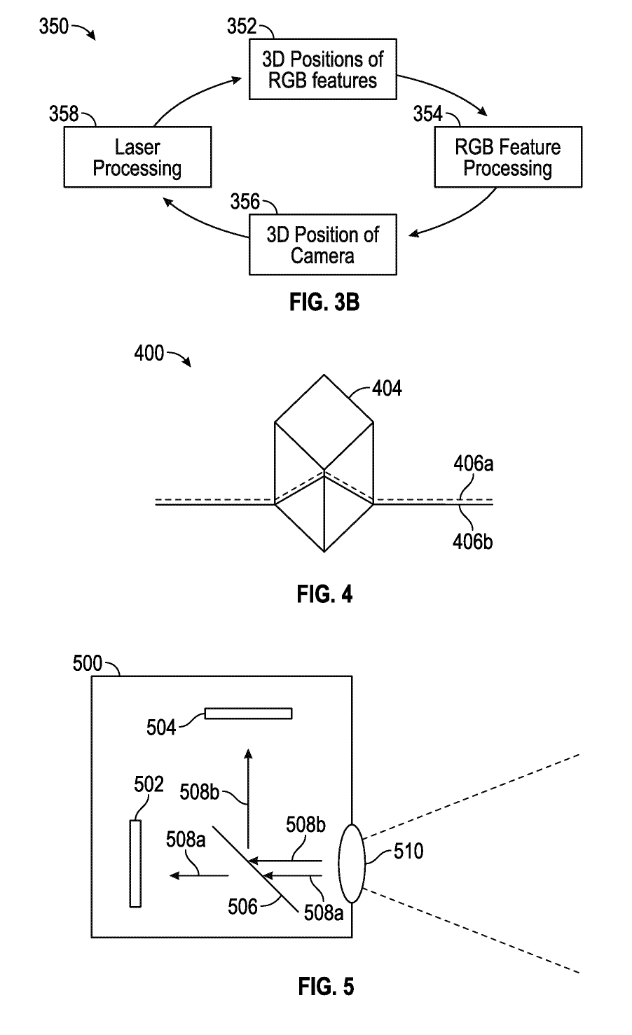

In some examples, the device can include a cold mirror (or, analogously, a hot mirror) configuration and two image sensors. The cold mirror configuration can be configured to transmit certain wavelengths of light (e.g., infrared wavelengths corresponding to the laser line) to a first image sensor, and reflect the remaining wavelengths of light (e.g., light corresponding to the image of the object, other than the infrared wavelengths) to a second image sensor. In this way, the device can readily identify the laser line and its deflections in the light transmitted through the cold mirror configuration, and can correlate the identified position/deflections in the laser line with the image data reflected to the second image sensor. An exemplary implementation of using a cold mirror configuration is described below with reference to FIG. 5.

In some examples, the image sensor in the device used to capture the image data at 302 can be a multi-spectrum RGB-IR image sensor that includes special infrared (IR) sub-pixels in each (or almost each) pixel on the sensor. The IR sub-pixels can be particularly sensitive to light in the infrared band, and if a laser line with a wavelength in the infrared band is utilized, the increased sensitivity of the IR sub-pixels can allow for increased visibility of the laser line in the image data, and thus easier identification of the laser line and/or its deflections in the image data.

In some examples, the SLAM device can include dual cameras (e.g., two image sensors). A first of the cameras can have no special bandpass filter applied to it (e.g., can be a normal RGB camera), so it can detect and capture full band (e.g., RGB) images of the object being scanned and the laser line. A second of the cameras can have a bandpass filter applied to it with a passband focused on (e.g., centered on) the wavelength of the laser line generated by the SLAM device. In this way, the second camera can be used to detect the laser line (and deflections in it), and the first camera can be used to capture full band (e.g., RGB) images of the object being scanned (e.g., for full RGB texturing and object feature detection). In some examples, the second camera can also be used to detect features of the object being scanned, despite having the bandpass filter applied to it.

In some examples, the SLAM device can include a single camera (e.g., one image sensor); however, half (or some other portion) of the camera's image sensor can have a bandpass filter applied to it with a passband focused on (e.g., centered on) the wavelength of the laser line generated by the SLAM device—the remainder of the camera's image sense can have no special bandpass filter applied to it, so it can detect and capture full band (e.g., RGB) images of the object being scanned and the laser line. In this way, a first portion of the camera's image sensor can be used to detect the laser line (and deflections in it), and a second portion of the camera's image sensor can be used to capture full band (e.g., RGB) images of the object being scanned (e.g., for full RGB texturing and object feature detection). In some examples, the first portion of the camera's image sensor can also be used to detect features of the object being scanned, despite having the bandpass filter applied to it. Additionally, in some examples, the SLAM device can dynamically alter to which half (or portion) of the camera's image sensor the bandpass filter is applied based on in which half (or portion) of the captured images the laser line is located. For example, the SLAM device can determine that the laser line is located in the bottom half of the captured images, and in response, can apply the bandpass filter to the bottom half of the camera's image sensor to improve the SLAM device's ability to detect the laser line. If the laser line changes to be in the top half of the captured images, the SLAM device can remove the bandpass filter from the bottom half of the camera's image sensor, and can instead begin applying it to the top half of the camera's image sensor.

In some examples, the SLAM device can generate a laser line that flashes with a particular temporal pattern or frequency. Thus, in addition to using one or more of the techniques described above to try to identify the laser line in the captured images of the object being scanned, the SLAM device can also look for the particular temporal pattern or frequency of flashing in the captured images to improve the accuracy of laser line detection. In some examples (e.g., in examples using a high frame rate camera, such as a camera with the ability to capture 240, 480, 960 or other numbers of frames per second), the particular pattern or frequency of the laser line flashing can be somewhat irregular, so as to reduce the likelihood that it will coincide with a pattern or frequency of some other changes captured in the images of the object being scanned. Further, in some examples, the SLAM device can actively vary the pattern or frequency of flashing of the laser line as the object is being scanned to further improve the differentiation of the laser line from the object and its environment. Such temporal pattern or frequency identification can also be used by the SLAM device in a configuration based on Lidar/time of flight laser line techniques, as described in more detail below.

At 306, the three dimensional positions (e.g., the absolute or relative positions) of points (e.g., pixels) along the laser line on the surface of the object being scanned can be determined based on deflections in the laser line. Exemplary techniques for determining the three dimensional positions of points (e.g., pixels) on the surfaces of objects using laser line deflection are described in Latimer, W., “Understanding laser-based 3D triangulation methods,” Vision Systems Design (June 2015), which is hereby incorporated by reference in its/their entirety for all purposes.

At 308, the points along the laser line determined at 306 can be added to a laser point cloud of the object being scanned. The points can be added to the laser point cloud based on the determined location of the camera (e.g., as described with reference to step 320) when the image data, including the laser line detected at 304, was captured at 302. Exemplary techniques for combining points along a laser line to create a laser point cloud and generating a three-dimensional mesh of an object are described in Kazhdan, M., “Poisson Surface Reconstruction,” Eurographics Symposium on Geometry Processing (2006), which is hereby incorporated by reference in its entirety for all purposes.

At 309, the SLAM device can determine whether the laser line is coincident with one or more features in the feature pool. If it is not, process 300 can return to step 302. If the laser line is coincident with one or more features in the feature pool, at 310, the three dimensional positions of those image features in the feature pool can be improved based on the positions of points on the laser line/in the laser point cloud determined at 306 and/or 308, because the three dimensional positions of features determined based on laser line deflections at 306 can be more accurate than the three dimensional positions of features determined based on optical image processing techniques at 320. For example, if the laser line is coincident with one or more features in the feature pool, the three dimensional positions of those one or more features in the feature pool can be improved based on the three dimensional positions of those features determined at 306 on the laser line (e.g., can be replaced by the three dimensional positions of those features determined at 306 based on laser line deflections).

Because steps 314, 316, 318 and 320 can be performed by the SLAM device in parallel with steps 304, 306, 308, 310 and 312, the improved three dimensional positions of the image features in the feature pool determined at 310 can be used at step 320 to improve the localization of the camera with respect to the object being scanned. This improved localization of the camera can be performed for one or more current and/or previously captured image frames of the object being scanned (e.g., the camera position associated with each image frame of the objects being scanned, and used to create the laser point cloud of the object being scanned at 308, can be updated with the improved camera position determined above).

At 312, using the improved localization of the camera (and/or the device including the camera) described above, the placement and/or stitching together of the laser points in the laser point cloud (e.g., constructed at 308) can be improved. Specifically, having improved accuracy for the position of the camera with respect to the object being scanned (and/or the points on the laser line) can improve the accuracy of where and how the points on the laser line should be added to the laser point cloud.

After step 312, process 300 can return to step 302 to capture further image data of the object(s) being scanned, until the SLAM process is complete. As a result of completion of process 300, a three dimensional point cloud, mesh and/or volume of the object(s) being scanned can be constructed, as described above. Process 300 can construct such a three dimensional point cloud, mesh and/or volume of the object(s) being scanned without the need for capturing an image of a calibration or reference image or marker for calibrating the SLAM device, and while allowing free movement of the SLAM device with respect to the object being scanned.

It is understood that process 300 (or modifications of process 300) can be used for laser-enhanced SLAM in slightly different contexts than those described in this disclosure. For example, process 300 can be used for SLAM of objects using Lidar sensors and one or more optical cameras (instead of using a laser line generator and one or more optical cameras, as described above). The Lidar sensors and the one or more optical cameras can be included in a drone, for example, or on an autonomous vehicle. In a Lidar implementation, which can emit ultraviolet, visible, or near infrared light beams in one or more directions, and can detect the reflections of those light beams from the object(s) being scanned, steps 302, 314, 316, 318 and 320 can continue to be performed as described above based on images captured by the one or more optical cameras. However, step 304 need not be performed (e.g., because identification of a laser line in an optical image may no longer be required), and step 306, during which three dimensional positions of points illuminated by laser light can be determined, can be performed using techniques other than laser line deflection (e.g., time of flight (ToF) techniques). For example, if a point on an object being scanned is depressed/indented, the ultraviolet, visible, or near infrared light beam incident on that point will take longer to reflect back to the Lidar sensors than a point on the object that is not depressed/indented. In other words, the further away a point on the object is, the longer it will take for the light beam to travel from the beam emitter to the point and reflect back to the Lidar sensors. In this way, the three dimensional positions of points on the object being scanned can be determined. The remainder of process 300 (e.g., steps 308, 310 and 312) can continue to be performed as described above.

Further, as previously mentioned, process 300 can be utilized to, rather than scan an object in three dimensions, only localize a camera. The steps of such a process can be substantially the same as those described with reference to FIG. 3A, the only change being that a resulting three dimensional point cloud, mesh and/or volume of the relevant object(s) need not be explicitly constructed and/or outputted by the process. Rather, the localization results of process 300 can be utilized as outputs from the process, as appropriate.

Additionally, process 300 can be slightly modified in some virtual reality (VR), augmented reality (AR) and robotics implementations. Specifically, in some implementations, it can be useful to perform a complete scan/mapping of an environment (e.g., an environment in which the VR/AR headset or robot will be operating) before using that scan/mapping to localize the camera (e.g., using SLAM) in the environment. Doing so can provide for subsequent reliable real-time tracking of the camera in the environment without the need to additionally concurrently map the environment. For example, when a user (or robot) first starts using the device (e.g., VR/AR headset) in a certain space, the user can first scan the space by, for example, standing in the middle of the space and scanning the laser line across the space (e.g., 360 degrees). In doing so, modified process 300 (e.g., the mapping steps of process 300, such as steps 302, 304, 306, 308, 309, 310 and 312, etc.) can be performed to provide an accurate and complete scan of the space (e.g., as an output from step 312). At this stage, modified process 300 need not perform camera localization steps (e.g., step 320); rather, the camera localization (e.g., step 320) and point cloud (e.g., step 312) can be optimized offline after the scanning in this stage is completed (e.g., all of the images of the environment can first be captured, and then the images can be combined/processed offline, including localizing the camera with each image, to complete the scan of the environment).

Once the user completes the scan of the environment and starts using VR/AR positional tracking or robot navigation, the device can begin to provide real-time localization of the camera in the environment (e.g., step 320) by comparing features detected in real-time to those features already in the feature pool from the previously-performed scan of the environment. The feature pool can be relatively complete from the previously-performed scan of the environment, so the focus of the process in this stage can be simply localizing the camera in the environment, without needing to substantially identify new features or scan the environment. As such, the tracking/localization of the camera (e.g., step 320) will not easily become lost even if the camera moves quickly, because a relatively complete feature pool of the environment was previously obtained in the scanning stage of modified process 300 (i.e., the camera can be relatively easily localized in the “pre-known” environment).

As previously discussed, process 300 of FIG. 3A can include a logical feedback loop such that determinations about feature locations, camera location, etc., can be used to improve other determinations made in the process, which can then be used to improve the determinations about feature locations, camera location, etc., and so on. FIG. 3B illustrates such a feedback loop 350 that can be a characteristic of process 300 of FIG. 3A, as previously described. Three-dimensional positions of RGB features can be determined at 352 (e.g., as described with reference to steps 310 and 320 in process 300). The three-dimensional positions of the RGB features determined at 352 can be used to improve RGB feature processing at 354 (e.g., improved position determinations for some RGB features can be used to improve the determined positions for other RGB features, and/or the improved positions of RGB features can be used as constraints (e.g., hard constraints) in feature localization algorithms, as described in this disclosure). The improved RGB feature processing at 354 can be used to improve the three-dimensional localization of the camera at 356 (e.g., as described with reference to steps 310 and 320 in process 300). The improved localization of the camera at 356 can be used to improve laser line processing at 358 (e.g., as described with reference to step 312 in process 300). Finally, the improved laser line processing at 358 can be used to improve the determined three-dimensional positions of RGB features at 352 (e.g., as described with reference to steps 310 and 320 in process 300), and so on. As such, logical feedback loop 350 can be continually navigated as process 300 is performed.

FIG. 4 illustrates an exemplary multi-wavelength laser generation configuration 400 according to examples of the disclosure. Object 404 can be an object to be scanned, as described in this disclosure. As previously described with reference to FIG. 3A, in some examples, the SLAM device can generate two or more laser lines of different wavelengths (e.g., red and green) to facilitate detection of the laser lines (and their deflections) for use in the SLAM techniques of the disclosure. In some examples, the generated laser lines can be close and/or parallel to each other, and separated from each other by a small amount (e.g., 1 mm, 3 mm or 5 mm). For example, in FIG. 4, laser line 406a can be a first laser line, and laser line 406b can be a second laser line. In some examples, more than two laser lines can be generated and utilized in accordance with the examples of the disclosure.

FIG. 5 illustrates an exemplary cold mirror image capture implementation according to examples of the disclosure. The configuration of FIG. 5 can be modified so as to realize a hot mirror implementation in a manner analogous to as will be described with reference to FIG. 5. Device 500 can be a camera used for SLAM, as described in this disclosure. Camera 500 can include aperture/lens 510 through which images of the object, illuminated by a laser line, that is being scanned can pass. The images of the object can include light in the infrared spectrum 508a as well as in the visible light spectrum 508b. The infrared 508a and visible 508b light can be incident on cold mirror 506. Cold mirror 506 can be a specialized dielectric mirror (e.g., a dichroic filter) that reflects substantially the entire visible light spectrum while efficiently transmitting infrared wavelengths. In some examples, cold mirror 506 can be oriented at 45 degrees with respect to the incoming light 508a and 508b. Because of its properties, cold mirror 506 can transmit the infrared light 508a to a first image sensor 502 in camera 500, and can reflect the visible light 508b to a second image sensor 504 in camera 500. The laser illuminated on the object being scanned can be easily visible in the infrared light 508a transmitted to the first image sensor 502 (assuming the wavelength of the laser is in the infrared spectrum), which can facilitate the SLAM device's ability to identify it, as previously described. The SLAM device can then utilize the images captured by the first 502 and second 504 sensors to perform the SLAM of the disclosure.

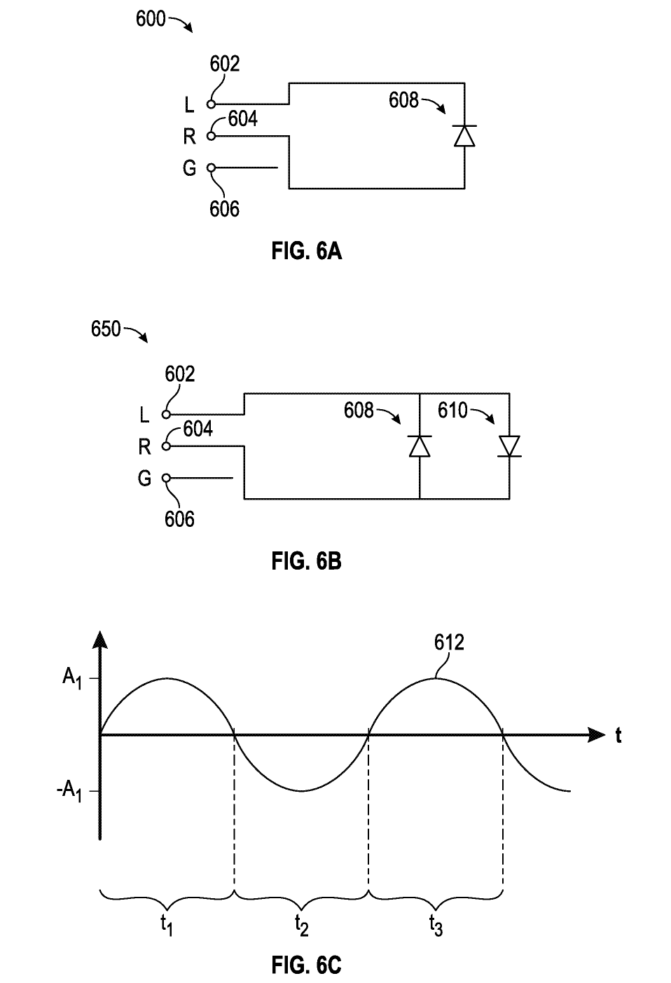

FIGS. 6A-6D illustrate exemplary details of laser line generators for use as attachments to a headphone jack on a device according to examples of the disclosure. As previously discussed, in some examples, the SLAM techniques of the disclosure can be performed on a smartphone (or equivalent device) that includes a built-in camera, but no built-in laser line generator. In such circumstances, a laser line generator can be attached to the device to give the device the ability to perform the SLAM techniques of the disclosure. One such laser line generator can be a device that attaches to the smartphone via a stereo headphone jack (e.g., a 3.5 mm or other headphone jack) on the smartphone, details of which will be described below.

FIG. 6A illustrates an exemplary circuit diagram 600 for a laser line generator configured for attachment to a headphone jack according to examples of the disclosure. The laser line generator can include a left-channel audio terminal 602, a right-channel audio terminal 604 and a ground terminal 606 (e.g., corresponding to physical connectors/regions on the headphone plug to be plugged into the headphone jack). The laser line generator can also include a laser diode (LD) 608 coupled to the left 602 and right 604 terminals. Specifically, one terminal of LD 608 can be coupled to the left terminal 602, and the other terminal of LD 608 can be coupled to the right terminal 604, as illustrated. It is understood that the ordering of left 602 and right 604 terminals to which LD 608 is coupled can be reversed, instead, within the scope of the disclosure. LD 608 can generate one or more of the laser lines disclosed above in this disclosure.

LD 608 can generate laser light when it is forward-biased, and can generate no laser light when it is reverse-biased. Thus, the device into which the laser line generator is plugged can supply current signals (e.g., audio signals) to its headphone jack to turn on/off LD 608 as appropriate, as will be described in more detail later. In this way, the laser line generator of FIG. 6A can generate a flashing laser line, as previously described in this disclosure.

FIG. 6B illustrates another exemplary circuit diagram 650 for a laser line generator configured for attachment to a headphone jack according to examples of the disclosure. The laser line generator of FIG. 6B can be substantially the same as that of FIG. 6A, except it can include a second LD 610. LD 610 can be coupled to left 602 and right 604 terminals in parallel with LD 608, though with opposite polarity, as illustrated. In this way, when LD 608 is forward-biased (and generating laser light), LD 610 can be reverse-biased (and not generating laser light). Similarly, when LD 608 is reverse-biased (and not generating laser light), LD 610 can be forward-biased (and generating laser light). Thus, the laser line generator of FIG. 6B can be substantially continuously generating a laser line. In some examples, LD 608 and LD 610 can generate the same wavelength laser lines, and in some examples, LD 608 and LD 610 can generate different wavelength laser lines (and thus can generate one or more laser lines that flash between two colors, such as red and green, in accordance with the frequency of the driving signal(s) of the laser line generators).

FIG. 6C illustrates an exemplary current signal 612 for driving the laser line generators of FIGS. 6A and/or 6B according to examples of the disclosure. The smartphone (or equivalent device) to which the laser line generators of FIGS. 6A and/or 6B can be attached via a headphone jack can generate current signal 612 (e.g., as an audio signal) to drive the laser line generators of FIGS. 6A and/or 6B. Signal 612 can be a sine or cosine signal with amplitude A₁, though in some examples, signal 612 can be a square wave with amplitude A₁ (with the same frequency as signal 612, illustrated) to increase the power supplied to LD 608 and/or 610. During time t₁, signal 612 can be positive, which can cause LD 608 (in FIGS. 6A and 6B) to generate laser light, and LD 610 (in FIG. 6B) to not generate laser light. During time t₂, signal 612 can be negative, which can cause LD 608 (in FIGS. 6A and 6B) to not generate laser light, and LD 610 (in FIG. 6B) to generate laser light. This pattern of behavior can continue as signal 612 moves from positive to negative. In this way, a headphone jack of a smartphone (or equivalent device) can be used to generate one or more laser lines in accordance with the examples of the disclosure.

FIG. 6D illustrates another exemplary driving scheme for driving the laser line generators of FIGS. 6A and/or 6B according to examples of the disclosure. The driving scheme of FIG. 6D can include generation, by the smartphone (or equivalent device) to which the laser line generators of FIGS. 6A and/or 6B can be attached via a headphone jack, of current signals 614 and 616 (e.g., as audio signals) to drive the laser line generators of FIGS. 6A and/or 6B. Specifically, signal 614 can be generated at the left terminal 602, and signal 616 can be generated at the right terminal 604. Signals 614 and 616 can both be sine or cosine signals with amplitude A₁, though in some examples, signals 614 and 616 can be square waves with amplitude A₁ (with the same frequency as signals 614 and 616, illustrated) to increase the power supplied to LD 608 and/or 610. Additionally, signal 616 can be phase shifted with respect to signal 614 by half a period, which can double the current intensity supplied to LDs 608 and 610 at any moment in time, and thus increase the brightness of the laser lines generated by LDs 608 and 610. Specifically, during time t₁, signal 614 can be positive and signal 616 can be negative, which can cause LD 608 (in FIGS. 6A and 6B) to generate laser light driven by a net current intensity of 2*A₁, and LD 610 (in FIG. 6B) to not generate laser light. During time t₂, signal 614 can be negative and signal 616 can be positive, which can cause LD 608 (in FIGS. 6A and 6B) to not generate laser light, and LD 610 (in FIG. 6B) to generate laser light driven by a net current intensity of 2*A₁. This pattern of behavior can continue as signals 614 and 616 alternate from positive to negative. As such, the driving scheme of FIG. 6D can deliver double the current intensity to LDs 608 and/or 610 than the driving scheme of FIG. 6C, resulting in brighter laser line generation despite utilizing signals having the same amplitude as the signals used in the scheme of FIG. 6C. In this way, the utilization of power received from the headphone jack of a smartphone (or equivalent device) can be maximized. Further, because the laser line generators of FIGS. 6A and/or 6B can utilize power delivered from the headphone jack of a device to operate, and do not require power from a different source, the laser line generator attachments can be relatively small and light.

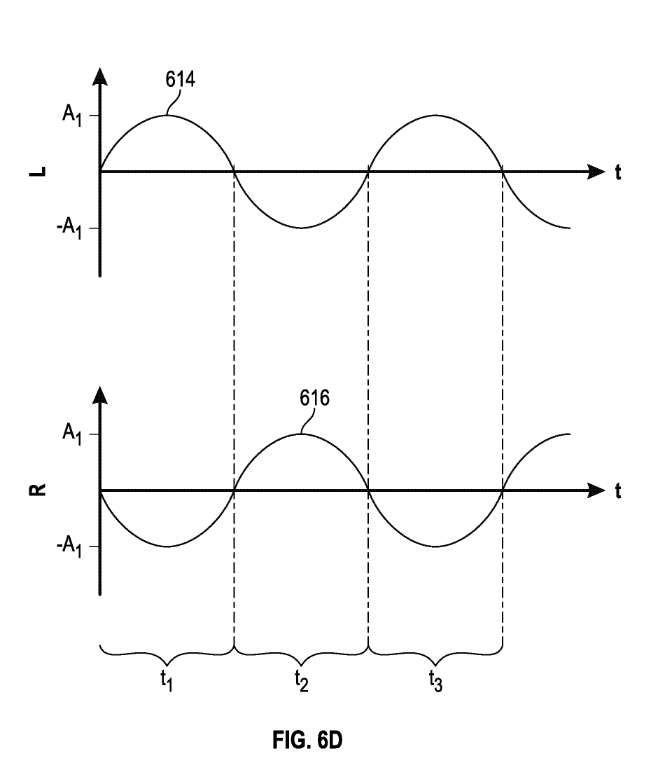

In some examples of the disclosure, the laser line generated by the SLAM device can move (e.g., scan over) the object being scanned without the need to move the SLAM device to achieve such movement. FIGS. 7A-7C illustrate exemplary techniques for moving the laser line across an object being scanned without needing to move the SLAM device, according to examples of the disclosure. In FIG. 7A, a camera 704 (e.g., corresponding to camera 104 in FIG. 1) and laser line generator 706 (e.g., corresponding to laser line generator 106 in FIG. 1) included in an exemplary SLAM device of the disclosure are illustrated. Laser line generator 706 can include a laser beam generator, which can generate and direct a laser beam to and through an appropriate lens. The lens can cause the laser beam to fan out as a laser plane 710. The lens can rotate (e.g., via an appropriate motor mechanism), which can cause the laser plane 710 to move/sweep across the object being scanned. As such, the laser line can move across the object being scanned without the need to move the SLAM device, and the SLAM techniques of this disclosure can be performed.

In FIG. 7B, a camera 704 and two laser line generators 706A and 706B included in an exemplary SLAM device of the disclosure are illustrated. Laser line generator 706A can generate a laser line along a first axis (e.g., vertical axis), and laser line generator 706B can generate a laser line along a second axis (e.g., horizontal axis). Laser line generators 706A and 706B can be configured to rotate to sweep their respective laser lines across the object being scanned. Further, in some examples, laser line generators 706A and 706B can be configured to rotate such that while laser line generator 706A is generating the laser line along the first axis and sweeping its laser line across the object being scanned, the laser line from 706B can be hidden from view (e.g., not incident on the object). Once the laser line generated by laser line generator 706A has completed its sweep across the object, its laser line can become hidden from view (e.g., not incident on the object), and the laser line generated by laser line generator 706B can become incident on the object and can sweep across the object. Such alternating sweeping of laser lines from laser line generators 706A and 706B can continue as the object is scanned. As such, the laser lines can move across the object being scanned without the need to move the SLAM device, and the SLAM techniques of this disclosure can be performed.

In FIG. 7C, a camera 704 and a laser line generator 706 included in an exemplary SLAM device of the disclosure are illustrated. Laser line generator 706 can be a phased array laser beam generator. The laser beams generated by the phased array laser beam generator can be directed to lens 708, which can fan out the phased array laser beams into corresponding laser planes that can be directed toward, and incident on, the object being scanned. As different-phased laser beams are generated by the phased array, the direction in which the laser beams are fanned out into laser planes by lens 708 can change, which can cause the laser planes to move across (e.g., rotate across) the object being scanned. In the example of FIG. 7C, lens 708 can be static (e.g., not rotating or moving), in contrast to the example of FIG. 7A. As such, the laser line can move across the object being scanned without the need to move the SLAM device, and the SLAM techniques of this disclosure can be performed.

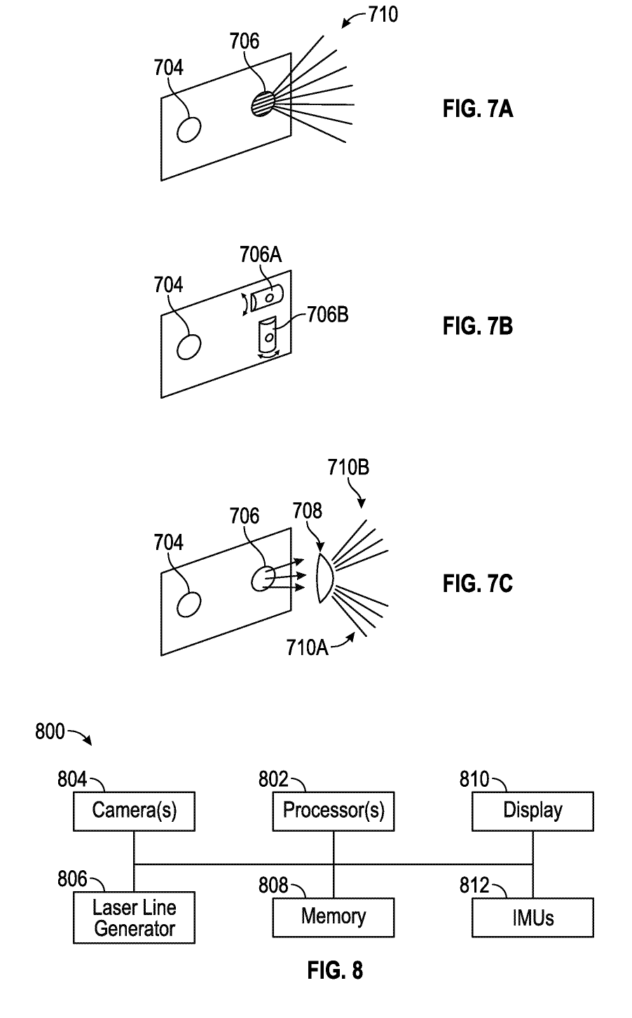

FIG. 8 illustrates an exemplary block diagram 800 of a SLAM device according to examples of the disclosure. SLAM device 800 can perform any of the methods described with reference to FIGS. 1-7. SLAM device 800 can be any number of electronic devices, such as a smartphone, a dedicated scanning device, etc. SLAM device 800 can include one or more cameras 804 (e.g., camera 104 in FIG. 1), one or more processors 802, a display (e.g., an LCD or other type of display), one or more inertial measurement units (IMUs) 812 (e.g., including one or more accelerometers, gyroscopes, magnetometers, etc.), memory 808 and one or more laser line generators 806 (e.g., laser line generator 106 in FIG. 1), which can all be coupled together, whether directly or indirectly. Processor(s) 802 can be capable of performing the three-dimensional scanning and/or camera tracking methods described with reference to FIGS. 1-7 of this disclosure. Additionally, memory 808 can store data and instructions for performing any of the methods described with reference to FIGS. 1-7. Memory 808 can be any non-transitory computer readable storage medium, such as a solid-state drive or a hard disk drive, among other possibilities. In some examples, camera(s) 804 can capture image data of an object and/or laser line as described in this disclosure, laser line generator(s) 806 can generate one or more laser lines as described in this disclosure, IMU(s) 812 can track motion of the SLAM device as described in this disclosure, processor(s) 802 can perform the three-dimensional scanning and/or camera tracking as described in this disclosure, and display 810 can provide visual feedback, to a user of the SLAM device, of the three-dimensional scanning and/or camera tracking performed by the SLAM device.

Thus, the examples of the disclosure provide various laser-enhanced techniques for scanning one or more objects and their environment in three dimensions, and localizing the camera, without the need for calibration and/or reference images or markers.

Therefore, according to the above, some examples of the disclosure are directed to a method comprising: at an electronic device in communication with a camera and a laser line generator: generating a laser line, with the laser line generator, the laser line incident on an object; while the laser line is incident on the object, capturing, with the camera, one or more images of the object with the laser line incident on the object; and localizing the camera based on one or more characteristics of the laser line incident on the object. Additionally or alternatively to one or more of the examples disclosed above, in some examples, localizing the camera comprises: identifying one or more features of the object in the one or more images; determining locations for the one or more identified features of the object based on the one or more images; and improving the determined locations of the one or more features of the object based on one or more characteristics of the laser line incident on the object. Additionally or alternatively to one or more of the examples disclosed above, in some examples, the one or more characteristics of the laser line comprise one or more deflections of the laser line on the object and/or a temporal pattern of the laser line. Additionally or alternatively to one or more of the examples disclosed above, in some examples, improving the determined locations of the one or more features of the object comprises: determining one or more positions of one or more points on the object along the laser line; in accordance with a determination that the laser line is coincident with at least one of the one or more features of the object, improving the determined locations of the at least one of the one or more features of the object based on the one or more determined positions of the one or more points along the laser line; and in accordance with a determination that the laser line is not coincident with at least one of the one or more features of the object, forgoing improving the determined locations of the at least one of the one or more features of the object based on the one or more determined positions of the one or more points along the laser line. Additionally or alternatively to one or more of the examples disclosed above, in some examples, the method further comprises: adding the one or more points along the laser line to a laser point cloud of the object. Additionally or alternatively to one or more of the examples disclosed above, in some examples, the method further comprises: determining a location of the camera with respect to the object based on the determined locations of the one or more features of the object, wherein adding the one or more points along the laser line to the laser point cloud of the object is based on the determined location of the camera; improving the determined location of the camera with respect to the object based on the improved determined locations of the one or more features of the object; and updating a placement of the one or more points along the laser line in the laser point cloud of the object based on the improved determined location of the camera. Additionally or alternatively to one or more of the examples disclosed above, in some examples, the method further comprises: determining a location of the camera with respect to the object based on the determined locations of the one or more features of the object; and improving the determined location of the camera with respect to the object based on the improved determined locations of the one or more features of the object. Additionally or alternatively to one or more of the examples disclosed above, in some examples, the method further comprises repeating, a plurality of times, determining locations for one or more identified respective features of the object and improving the determined locations for the one or more respective features of the object based on one or more characteristics of the laser line incident on the object as the laser line is scanned across the object. Additionally or alternatively to one or more of the examples disclosed above, in some examples, the method further comprises: generating a three-dimensional representation of the object based on the repeated determinations of the locations for the one or more identified respective features of the object and the improvements of the determined locations for the one or more respective features of the object. Additionally or alternatively to one or more of the examples disclosed above, in some examples, the identifying, the determining and the improving are performed without using a reference image or reference object. Additionally or alternatively to one or more of the examples disclosed above, in some examples, the laser line comprises a plurality of laser lines having different wavelengths, and improving the determined locations of the one or more features of the object is based on one or more characteristics of the plurality of laser lines incident on the object. Additionally or alternatively to one or more of the examples disclosed above, in some examples, the camera comprises a cold mirror or a hot mirror configuration, including a first image sensor and a second image sensor, determining the locations for the one or more identified features of the object is based on image data captured by the first image sensor, and improving the determined locations of the one or more features of the object is based on image data captured by the second image sensor. Additionally or alternatively to one or more of the examples disclosed above, in some examples, the laser line generator is configured to scan the laser line across the object without movement of the camera or the electronic device. Additionally or alternatively to one or more of the examples disclosed above, in some examples, the laser line generator comprises a laser beam generator directed towards a rotating lens configured to create, based on a laser beam generated by the laser beam generator, the laser line incident on the object and scan the laser line across the object in accordance with rotation of the rotating lens. Additionally or alternatively to one or more of the examples disclosed above, in some examples, the laser line generator comprises a phased array laser beam generator directed towards a static lens configured to create, based on one or more laser beams generated by the phased array laser beam generator, the laser line incident on the object, wherein the laser line is scanned across the object in accordance with one or more phases of the one or more laser beams generated by the phased array laser beam generator. Additionally or alternatively to one or more of the examples disclosed above, in some examples, the one or more features of the object comprise one or more of corners of the object and texture features of the object. Additionally or alternatively to one or more of the examples disclosed above, in some examples, the camera comprises an RGB-IR image sensor. Additionally or alternatively to one or more of the examples disclosed above, in some examples, the laser line is incident on a scene including the object, and localizing the camera is with respect to the scene. Additionally or alternatively to one or more of the examples disclosed above, in some examples, the laser line is incident on the object and a second object, and localizing the camera is with respect to the object and the second object. Additionally or alternatively to one or more of the examples disclosed above, in some examples, the generating, capturing and localizing are performed for an environment, including the object, in which the electronic device is to be localized before the electronic device is localized in the environment, and the method further comprises: creating a map of the environment based on the generating, capturing and localizing; after creating the map of the environment, operating the electronic device in the environment, which includes localizing the electronic device in the environment based on the map of the environment. Additionally or alternatively to one or more of the examples disclosed above, in some examples, the electronic device comprises an augmented reality headset, a virtual reality headset, a robot, a drone or a car. Additionally or alternatively to one or more of the examples disclosed above, in some examples, localizing the electronic device in the environment includes identifying features in the environment in real-time, and comparing those features to features in the map of the environment. Additionally or alternatively to one or more of the examples disclosed above, in some examples, the localizing the camera is performed without using a reference image or reference object.

Some examples of the disclosure are directed to a system comprising: a camera; a laser line generator; one or more processors; and a memory including instructions, which when executed by the one or more processors, cause the one or more processors to perform a method comprising: generating a laser line, with the laser line generator, the laser line incident on an object; while the laser line is incident on the object, capturing, with the camera, one or more images of the object with the laser line incident on the object; and localizing the camera based on one or more characteristics of the laser line incident on the object. Additionally or alternatively to one or more of the examples disclosed above, in some examples, the camera, the one or more processors and the memory are included in a first device, and the laser line generator is included in a second device, external to the first device, and configured to be attached to the first device.

Some examples of the disclosure are directed to a laser line generator configured to be attached to a headphone jack of an electronic device, the laser line generator comprising: a first laser diode having a first terminal and a second terminal, the first terminal of the first laser diode configured to be coupled to a first terminal of the headphone jack, and the second terminal of the first laser diode configured to be coupled to a second terminal of the headphone jack. Additionally or alternatively to one or more of the examples disclosed above, in some examples, the first terminal of the headphone jack and the second terminal of the headphone jack correspond to a left-channel audio terminal of the headphone jack and a right-channel audio terminal of the headphone jack, respectively. Additionally or alternatively to one or more of the examples disclosed above, in some examples, the laser line generator further comprises: a second laser diode coupled in parallel with the first laser diode and having a first terminal and a second terminal, the first terminal of the second laser diode configured to be coupled to the second terminal of the headphone jack, and the second terminal of the second laser diode configured to be coupled to the first terminal of the headphone jack, such that the second laser diode and the first laser diode are coupled to the headphone jack with opposite polarity.

Some examples of the disclosure are directed to a system comprising: a camera; a laser beam generator; one or more processors; and a memory including instructions, which when executed by the one or more processors, cause the one or more processors to perform a method comprising: generating a laser beam, with the laser beam generator, the laser beam incident on an object; while the laser beam is incident on the object, capturing, with the camera, one or more images of the object; and localizing the camera based on one or more characteristics of reflections of the laser beam incident on the object. Additionally or alternatively to one or more of the examples disclosed above, in some examples, the laser beam generator is configured to generate a laser line incident on the object using laser beam steering with a phased array or a fast spinning mirror.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method comprising:
at an electronic device in communication with a camera and a laser line generator:
generating a laser line, with the laser line generator, the laser line incident on an object;
while the laser line is incident on the object, capturing, with the camera, one or more images of the object with the laser line incident on the object; and
localizing the camera based on one or more characteristics of the laser line incident on the object.

2. The method of claim 1, wherein localizing the camera comprises:
identifying one or more features of the object in the one or more images;
determining locations for the one or more identified features of the object based on the one or more images; and
improving the determined locations of the one or more features of the object based on one or more characteristics of the laser line incident on the object.

3. The method of claim 1, wherein the one or more characteristics of the laser line comprise one or more deflections of the laser line on the object and/or a temporal pattern of the laser line.

4. The method of claim 2, wherein improving the determined locations of the one or more features of the object comprises:
determining one or more positions of one or more points on the object along the laser line;
in accordance with a determination that the laser line is coincident with at least one of the one or more features of the object, improving the determined locations of the at least one of the one or more features of the object based on the one or more determined positions of the one or more points along the laser line; and
in accordance with a determination that the laser line is not coincident with at least one of the one or more features of the object, forgoing improving the determined locations of the at least one of the one or more features of the object based on the one or more determined positions of the one or more points along the laser line.

5. The method of claim 4, further comprising:
adding the one or more points along the laser line to a laser point cloud of the object.

6. The method of claim 5, further comprising:
determining a location of the camera with respect to the object based on the determined locations of the one or more features of the object, wherein adding the one or more points along the laser line to the laser point cloud of the object is based on the determined location of the camera;
improving the determined location of the camera with respect to the object based on the improved determined locations of the one or more features of the object; and
updating a placement of the one or more points along the laser line in the laser point cloud of the object based on the improved determined location of the camera.

7. The method of claim 2, further comprising:
determining a location of the camera with respect to the object based on the determined locations of the one or more features of the object; and
improving the determined location of the camera with respect to the object based on the improved determined locations of the one or more features of the object.

8. The method of claim 2, further comprising repeating, a plurality of times, determining locations for one or more identified respective features of the object and improving the determined locations for the one or more respective features of the object based on one or more characteristics of the laser line incident on the object as the laser line is scanned across the object.

9. The method of claim 8, further comprising:
generating a three-dimensional representation of the object based on the repeated determinations of the locations for the one or more identified respective features of the object and the improvements of the determined locations for the one or more respective features of the object.

10. The method of claim 2, wherein the identifying, the determining and the improving are performed without using a reference image or reference object.

11. The method of claim 2, wherein the laser line comprises a plurality of laser lines having different wavelengths, and improving the determined locations of the one or more features of the object is based on one or more characteristics of the plurality of laser lines incident on the object.

12. The method of claim 2, wherein:
the camera comprises a cold mirror or a hot mirror configuration, including a first image sensor and a second image sensor,
determining the locations for the one or more identified features of the object is based on image data captured by the first image sensor, and
improving the determined locations of the one or more features of the object is based on image data captured by the second image sensor.

13. The method of claim 1, wherein the laser line generator is configured to scan the laser line across the object without movement of the camera or the electronic device.

14. The method of claim 13, wherein the laser line generator comprises a laser beam generator directed towards a rotating lens configured to create, based on a laser beam generated by the laser beam generator, the laser line incident on the object and scan the laser line across the object in accordance with rotation of the rotating lens.

15. The method of claim 13, wherein the laser line generator comprises a phased array laser beam generator directed towards a static lens configured to create, based on one or more laser beams generated by the phased array laser beam generator, the laser line incident on the object, wherein the laser line is scanned across the object in accordance with one or more phases of the one or more laser beams generated by the phased array laser beam generator.

16. The method of claim 2, wherein the one or more features of the object comprise one or more of corners of the object and texture features of the object.

17. The method of claim 1, wherein the camera comprises an RGB-IR image sensor.

18. The method of claim 1, wherein the laser line is incident on a scene including the object, and localizing the camera is with respect to the scene.

19. The method of claim 1, wherein the laser line is incident on the object and a second object, and localizing the camera is with respect to the object and the second object.

20. The method of claim 1, wherein the generating, capturing and localizing are performed for an environment, including the object, in which the electronic device is to be localized before the electronic device is localized in the environment, and the method further comprises:
creating a map of the environment based on the generating, capturing and localizing;
after creating the map of the environment, operating the electronic device in the environment, which includes localizing the electronic device in the environment based on the map of the environment.

21. The method of claim 20, wherein the electronic device comprises an augmented reality headset, a virtual reality headset, a robot, a drone or a car.

22. The method of claim 20, wherein localizing the electronic device in the environment includes identifying features in the environment in real-time, and comparing those features to features in the map of the environment.

23. The method of claim 1, wherein the localizing the camera is performed without using a reference image or reference object.

24. A system comprising:
a camera;
a laser line generator;
one or more processors; and
a memory including instructions, which when executed by the one or more processors, cause the one or more processors to perform a method comprising:
generating a laser line, with the laser line generator, the laser line incident on an object;
while the laser line is incident on the object, capturing, with the camera, one or more images of the object with the laser line incident on the object; and
localizing the camera based on one or more characteristics of the laser line incident on the object.

25. The system of claim 24, wherein the camera, the one or more processors and the memory are included in a first device, and the laser line generator is included in a second device, external to the first device, and configured to be attached to the first device.

26-28. (canceled)

29. A system comprising:
a camera;
a laser beam generator;
one or more processors; and
a memory including instructions, which when executed by the one or more processors, cause the one or more processors to perform a method comprising:
generating a laser beam, with the laser beam generator, the laser beam incident on an object;
while the laser beam is incident on the object, capturing, with the camera, one or more images of the object; and
localizing the camera based on one or more characteristics of reflections of the laser beam incident on the object.

30. The system of claim 29, wherein the laser beam generator is configured to generate a laser line incident on the object using laser beam steering with a phased array or a fast spinning mirror.
